(19) United States
(12) Patent Application Publication
(10) Pub. No.: US 2010/0276208 A1
(43) Pub. Date: Nov. 4, 2010

(54) HIGH THERMAL CONDUCTIVITY HARDFACING FOR DRILLING APPLICATIONS

(76) Inventor: Jiinjen Albert Sue, The Woodlands, TX (US)

Correspondence Address: Conley Rose P.C, P.O.Box 3267, Houston, TX, 77253, US

(21) Appl. No.: 12/432,179

(22) Filed: Apr. 29, 2009

(51) Int. Cl. E21B 10/46; E21B 10/42; E21B 10/08; E21B 10/50; E21B 10/54; C09D 1/00

(52) U.S. Cl. 175/374; 175/425; 106/286.1

(57) ABSTRACT

A high thermal conductivity hardmetal composition comprising tungsten carbide in a nickel based matrix binder is disclosed. The hardmetal has at least 50 wt % tungsten carbide, the tungsten carbide being composed of at least 50 vol % of spherical particles. The binder material is composed of at least 98.5 wt % of components selected from the group consisting of nickel, boron, and silica, and the binder flux of boron plus silica content ranges from between 3.5 to 10.0 wt % of the binder material.

### TECHNICAL FIELD

The present invention relates generally to the field of drilling equipment used in drilling a bore hole, such as the drilling and completing of oil and gas wells, and more particularly to hardfacing material that provides improved durability to drilling equipment.

### BACKGROUND

Oil and gas wells can be formed by rotary drilling processes that involve a drill bit connected onto the end of a drill string. Rotational motion of the drill bit in contact with the earth can create a wellbore by the earth boring action of the drill bit. The rotational motion of the drill bit can be provided by a rotary drive mechanism located at the surface that turns the drill string that in turn gives motion to the drill bit. Alternately a downhole motor can be used to convert hydraulic pressure of a circulating fluid into rotational motion of the drill bit, enabling drilling of the well without the need to turn the entire drill string.

During drilling operations a fluid, referred to as drilling fluid or drilling mud, can be circulated through the drill string and up through the wellbore to the surface. The drilling fluid is used to remove the cuttings resulting from the drilling process, reduce the occurrence of plugging of the drill bit, and can be used to cool the areas of contact between the bit and the formation that can generate heat.

One basic type of drill bit in general use for drilling a wellbore are rotary cone bits, which can also be referred to as rolling cutter bits, milled tooth bits, or rock bits. These generally use one or more rolling cones containing projections called cutting teeth. The cones are mounted on a drill bit body such that when the drill bit body is rotated and weight is applied the teeth engage the formation being drilled and the cone rotates, imparting a boring action that forms the wellbore.

Another basic type of drill bit in general use is fixed cutter drill bits which can also be referred to as drag bits. A fixed cutter drill bit uses cutting elements that are attached to a drill bit body. When the fixed cutter drill bit is rotated and weight applied the cutting elements contact the formation being drilled in a shearing action that breaks off pieces of the formation and forms the wellbore.

Certain surfaces of both rock bits and drag bits as well as other drilling related tools such as reamers, V-stab and stabilizers can be subject to wear during the drilling process, such as the side surface of a bit body that is contact with the wellbore wall and surface areas between the cutting elements of a drag bit. These surfaces can have a layer of material that is designed to resist wear applied, which can be referred to as hardfacing or hardmetal.

Conventional hardmetal materials used to provide wear resistance to the underlying substrate of the drill bit can comprise carbides. The carbide materials are used to impart properties of wear resistance and fracture resistance to the bit. Conventional hardmetal materials useful for forming a hardfaced layer can also include one or more alloys to provide desired physical properties.

The hardfaced layer is typically applied onto the underlying bit surface by conventionally known welding methods or thermal spray techniques, such as Laser Cladding, Plasma Transferred Arc or Flame Spray techniques. The associated thermal impact of these processes can cause thermal stress and cracking to develop in the material microstructure, which can cause premature chipping, flaking, fracturing, and ultimately failure of the hardfaced layer.

Additionally, the process of welding the hardmetal materials onto the underlying substrate can make it difficult to provide a hardfaced layer having a consistent coating thickness, which can determine the service life of the bit.

It is desirable that a wear and fracture resistant hardmetal material, and method for applying the same, for use on drilling equipment be developed that avoids the undesired impact due to the thermal effect on the material during application and can provide improved properties of dimensional consistency and accuracy.

### SUMMARY

One embodiment of the present invention is a high thermal conductivity hardmetal composition that includes tungsten carbide and a binder material. The tungsten carbide is present in an amount greater than 50 weight percent of the hardmetal composition and at least 50 volume percent of the tungsten carbide particles are spherical in shape. The binder material consists of at least 90 weight percent nickel, a binder flux of between 3.5 to 10.0 weight percent chosen from the group consisting of boron and silica, and less than 1.0 weight percent other components.

The hardmetal can have good deposition fluidity and have a tungsten carbide content weight percent in the hardmetal from eight to eleven times the binder flux content weight percent of the binder. The hardmetal can have a low stress abrasion (ASTM G65) of less than 2.0 cm³/1000 revolution and can have a high stress abrasion (ASTM B611) of less than 1.0 cm³/1000 revolution.

The hardmetal can be applied to an underlying metal via a thermal spray technique, such as by laser cladding, plasma transferred arc, or flame spray processes. The binder material can have a thermal conductivity of greater than 31.0 Watt/m·° K. The hardmetal can be applied to tools chosen from the group consisting of drill bit, rotary cone bit, drag bit, mill tooth bit, reamer, under-reamer, stabilizer and centralizer.

In another embodiment, the invention is a drill bit having a bit body with at least one high thermal conductivity hardmetal surface affixed to the bit body. The hardmetal having tungsten carbide in an amount greater than 50 weight percent of the hardmetal composition and at least 50 volume percent of the tungsten carbide particles being spherical. The hardmetal also has a binder material consisting of at least 90 weight percent nickel, a binder flux of between 3.5 to 10.0 weight percent chosen from the group consisting of boron and silica, and less than 1.0 weight percent other components. The drill bit can be a rotary cone bit or can be a drag bit. The hardmetal can have a low stress abrasion of less than 1.3 cm³/1000 revolution and a high stress abrasion of less than 1.0 cm³/1000 revolution. The hardmetal can be applied to the bit body via a thermal spray technique, such as by laser cladding, plasma transferred arc, or flame spray processes. The hardmetal binder material can have a thermal conductivity of greater than 31.0 Watt/m·° K.

Yet another embodiment of the present invention is a method for providing a wear resistant material onto a tool comprising the steps of providing a hardmetal composition consisting of tungsten carbide and a binder material and affixing the hardmetal composition to portions of the tool by a thermal spray process. The tungsten carbide is present in an amount greater than 50 weight percent of the hardmetal composition and at least 50 volume percent of tungsten carbide particles are spherical in shape. The binder material consists of at least 90 weight percent nickel, a binder flux of between 3.5 to 10.0 weight percent chosen from the group consisting of boron and silica, and less than 1.0 weight percent other components.

The hardmetal composition can have good deposition fluidity and the tungsten carbide content (wt %) in the hardmetal can range from eight to eleven times the binder flux content (wt %) of the binder. The hardmetal can be applied to the tool via a thermal spray technique, such as laser cladding, plasma transferred arc, or flame spray. The tool can be chosen from the group consisting of drill bit, rotary cone bit, drag bit, mill tooth bit, reamer, under-reamer, stabilizer and centralizer.

In another embodiment, the present invention is a high thermal conductivity hardmetal composition comprising tungsten carbide and a binder material. The tungsten carbide is present in an amount greater than 60 wt % of the hardmetal composition, the tungsten carbide having at least 50 vol % of spherical tungsten carbide particles. The binder material consists of a ductile Ni—B—Si matrix composed of at least 98.5 wt % of components selected from the group consisting of nickel, boron, and silica. The binder material has a binder flux content of boron plus silica ranging from 5.0 to 9.0 wt % of the binder material and the binder material has a thermal conductivity of greater than 31.0 Watt/m·° K. The hardmetal composition has good deposition fluidity and the tungsten carbide content wt % in the hardmetal composition ranges from nine to eleven times the binder flux content wt % of the binder. The hardmetal composition has a low stress abrasion of less than 2.0 cm³/1000 revolution and has a high stress abrasion of less than 0.75 cm³/1000 revolution.

### BRIEF DESCRIPTION OF THE DRAWINGS

FIG. 1 is a diagrammatic view of a typical downhole steerable drilling system.

FIG. 2 is a perspective view of a drag bit.

FIG. 3 is a view of an end of the drill bit of FIG. 2.

FIG. 4 is a view of one of the blades of the drill bit of FIG. 2.

FIG. 5 is a perspective view of a rock bit.

FIG. 6 is a perspective view of a stabilizer.

FIG. 7 is a graph of carbide content versus binder flux content for various hardmetal compositions.

FIG. 8 provides microstructure images of embodiments of the invention.

FIG. 9 provides microstructure images of comparative hardmetal compositions.

### DETAILED DESCRIPTION

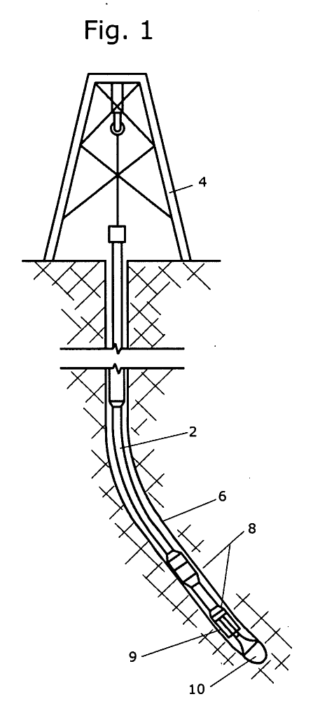

FIG. 1 shows a drill string 2 suspended by a derrick 4 for drilling a wellbore 6 into the earth for minerals exploration and recovery, and in particular petroleum. A bottom-hole assembly (BHA) 8 is located at the bottom of the drill string 2. In directional drilling, the BHA 8 can have a downhole steerable drilling system 9 and comprises a drill bit 10. As the drill bit 10 rotates it cuts into the earth allowing the drill string 2 to advance, thus forming the wellbore 6. In non-directional drilling applications the BHA may not include a steerable drilling system and may consist of a drill bit, typically with one or more drill collars, and optionally other tools to improve stability.

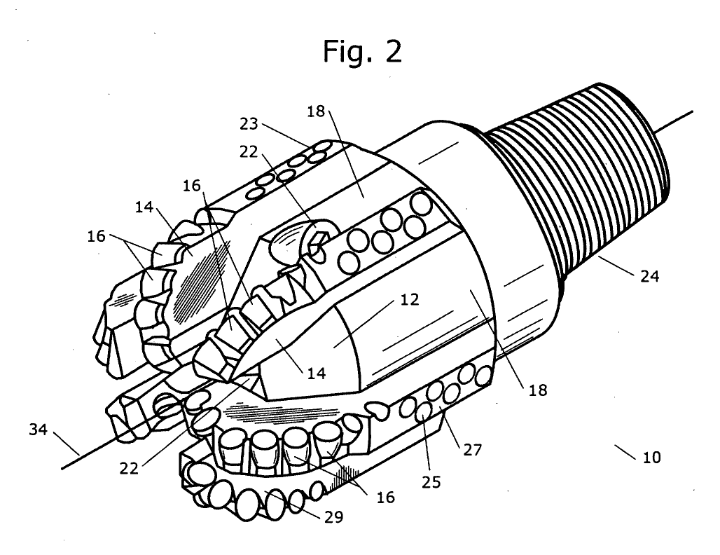

FIG. 2 shows an example of a rotary drag bit having a bit body 10 made of a material such as machined steel. The bit body 10 has a leading face 12 provided with a plurality of protruding, radially spaced blades 14. Each blade 14 carries a plurality of cutting elements 16. Between each pair of adjacent blades 14 is defined a channel 18 which is supplied, while in use, with drilling fluid through a series of passages 20 provided internally of the drill bit body 10, each passage 20 terminating at a nozzle 22. The supply of drilling fluid serves to clean and cool the cutting elements 16 while in use and provide a means of circulating cuttings out of the wellbore.

The blades 14 continue from the leading face 12 onto the bit body 10 to form a gage contact surface 23 that defines the outer diameter of the bit 10. The gage contact surface 23 can include wear resistant inserts 25 pressed into the gage contact surface 23, which can further have a hardfacing matrix 27 surrounding the wear resistant inserts 25. Contact between the gage contact surface 23 and the wellbore can lead to wear and to elevated temperatures of the hardfacing matrix 27.

The cutting elements 16 can also be located within a hardfacing matrix 29, or within pockets in the blades 14, that are surrounded by a hardfacing matrix 29 that can cover some or all of the blades 14 and can protrude from the blades 14 and fill some or all of the area between the cutting elements 16, which can be referred to as webbing, between the cutting elements 16. Contact between the hardfacing matrix 29 adjacent the cutting elements 16 and the shearing action forming the wellbore can lead to wear and to elevated temperatures of the hardfacing matrix 29.

The bit body 10 is shaped to include a threaded shank 24 to permit the drill bit to be connected to the remainder of a drill string and to permit the bit to be driven to rotate about an axis of rotation 34 thereof.

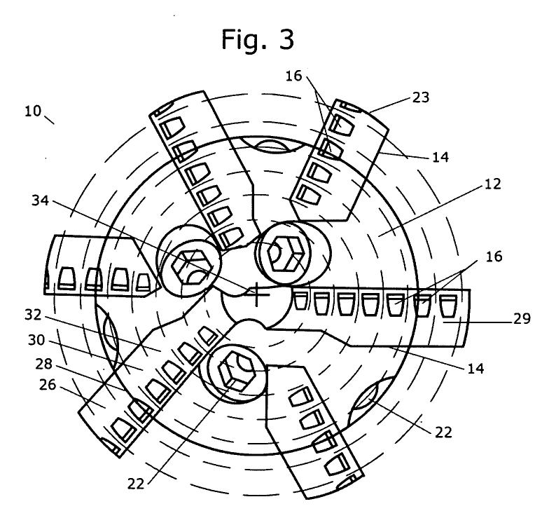

As illustrated in FIG. 3, the cutters 16 can be arranged on the blades 14 in a series of concentric rings 26, 28, 30, 32. The concentric rings 26, 28, 30, 32 are centered upon the axis of rotation 34 of the bit body 10. The areas between the concentric rings 26, 28, 30, 32 are areas where the hardfacing matrix 29 webbing between the cutting elements 16 can experience severe wear and thermal stress.

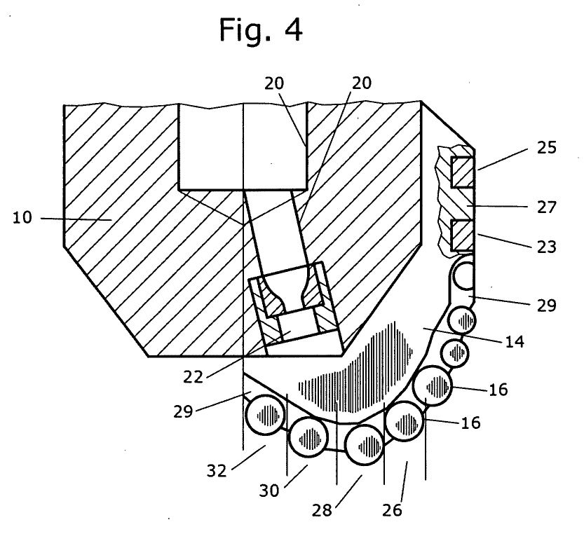

FIG. 4 provides a cross-sectional view of the drill bit 10 that shows the face of a blade 14, the placement of the cutting elements 16 and of the wear resistant inserts 25. Also shown are the hardfacing matrix areas 27 on the gage contact surface 23 and the webbing 29 between the cutting elements 16 that can experience severe wear and thermal stress.

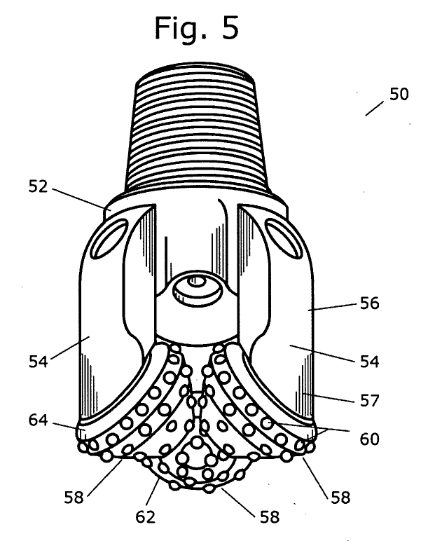

Referring now to FIG. 5, a rolling cutter drill bit 50 includes a body 52 (portions of which are not shown). The body 52 of a typical rolling cutter drill bit comprises three similar leg portions 54 (only two are shown) that include an external surface 56 on each leg portion 54. The external surface includes a shirttail region 57 near the bottom of the leg portion 54. The external surface 56 and/or shirttail region 57 can be covered with a hardfacing material and can be referred to as a hardfacing matrix. Contact between the hardfacing matrix and the wellbore can lead to wear and to elevated temperatures of the hardfacing matrix. A rolling cutter 58 is rotatably mounted upon each leg portion 54. Attached to the rolling cutter 58 are cutting inserts 60 which engage the earth to effect a drilling action and cause rotation of the rolling cutter 58. The exposed surface 62 of the rolling cutter 58 surrounding the cutting inserts 60 can be covered with a hardfacing material and can be referred to as a hardfacing matrix. Contact between the hardfacing matrix and the wellbore can lead to wear and to elevated temperatures of the hardfacing matrix.

The portion of the rolling cutter 58 near the leg portion 54 can be referred to as the rolling cutter gage contact surface 64 and can also have a hardfacing matrix applied. The rolling cutter gage contact surface 64 is a generally conical surface at the heel of a rolling cutter 58 that can engage the sidewall of a wellbore as the bit is used. Contact between the rolling cutter gage contact surface 64 and the wellbore can lead to wear and to elevated temperatures of the hardfacing matrix located on the rolling cutter gage contact surface 64.

Although FIG. 5 and the discussion herein references a rolling cutter bit having cutting inserts, the present invention is not limited to the same and includes other bit designs such as mill tooth bits having teeth protrusions from the come rather than inserts. The hardfacing can be applied on the external surface, shirttail region and webbing between the teeth, as well as the surface of the teeth themselves.

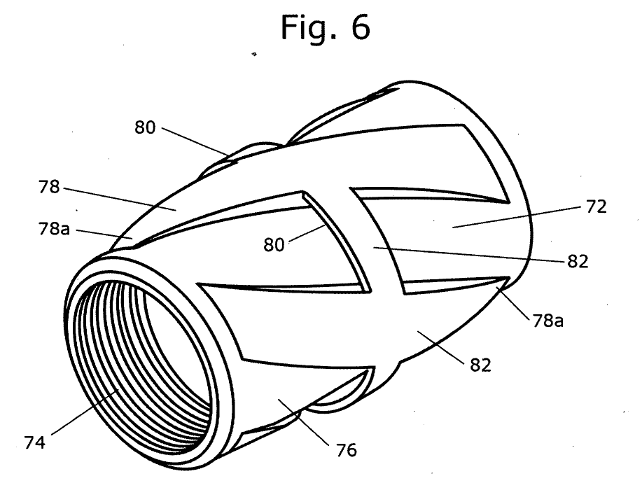

Referring to FIG. 6, a stabilizer 70 is shown comprising a generally cylindrical body 72 with screw-threaded recesses 74 arranged to mate with adjacent components of the drill string or BHA. The outer wall 76 of the body 72 is provided with a plurality of upstanding blades 78. Each blade 78 is of substantially uniform height along its length, other than at its ends 78a where it can taper to the diameter of the body 72. The blades 78 are substantially equally spaced around the body 72, in this case in a generally spiral form. One or more bridging regions 80 can be provided that can interconnect a pair of adjacent blades 78. The surface 82 of the blades and/or bridging regions 80 can have a hardmetal applied for wear resistance and can optionally contain wear resistant inserts (not shown).

In an alternate embodiment the blades 78 can have a substantially uniform height along its length and not taper at the ends. In an alternate embodiment the blades 78 are generally linear along the length of the body 72 and are not in a spiral form. In an alternate embodiment there are no bridging regions 80 between the blades 78. Although FIG. 6 refers to a stabilizer the present invention is not limited to the same and includes other drilling equipment such as reamers, under-reamers, V-stab, centralizers, and the like.

Embodiments of the present invention include surfaces formed from the application of engineered wear and fracture resistant material having high thermal conductivity. The wear and fracture resistant material is generally disposed onto an underlying bit surface using any hardfacing application process, such as thermal spray. The invention can include one or more layers of wear and fracture resistant materials disposed over a surface to provide improved properties of wear and fracture resistance. Such functionally-engineered wear and fracture resistant materials include high thermal conductivity materials that avoid the introduction of unwanted thermal effects inherent with welding or thermal spray, and that avoids dimensional inconsistencies.

Generally speaking, materials used to provide wear and fracture resistant surfaces to drilling equipment of the present invention have engineered compositions to provide high thermal conductivity resulting in superior properties of wear and fracture resistance when compared to conventional hardmetal materials. Thus, the high thermal conductivity materials and compositions of this invention act to overcome the failure mechanism discussed above of material wear loss associated with hardfaced layers formed from conventional hardmetal materials.

The basic structure of a drill bit, whether of a rotary cone or fixed cutter design, or other drilling equipment is well known and does not form a specific portion of this invention. Embodiments of the present invention relate to drill bits having high thermal conductivity wear resistant composite material surfaces, and methods for forming the same. Embodiments of the present invention also include the use of high thermal conductivity wear resistant composite material surfaces on drilling equipment other than drill bits, for example reamers that can be used to expand a wellbore diameter.

Generally speaking, for the effective use of a drill bit, it is important to provide as much wear resistance as possible on the portions of the bit that can have contact with the wellbore or in high erosion or other high wear conditions. The effective life of the bit is enhanced as wear resistance is increased. As wear occurs, the drill bit may be replaced when the rate of penetration decreases to an unacceptable level. It is, therefore, desirable to minimize wear so that the footage drilled by each bit is maximized. This not only decreases direct cost, but also decreases the frequency of having to “round trip” a drill string to replace a worn bit with a new one.

As gage contact surfaces wear, the diameter of the hole drilled by the bit may decrease, sometimes causing drilling problems or requiring “reaming” of the hole by the next bit used. Advances in wear resistance of the drill bit wear surfaces is desirable to increase the duration which a hole diameter (or gage) can be maintained, to enhance the footage a drill bit can drill before needing to be replaced, and to enhance the rate of penetration of such drill bits. Such improvements generally translate into reduction of drilling expense.

The wear and fracture resistant materials useful for forming rock bit surfaces of this invention can be applied onto a desired underlying substrate according to any suitable method. According to one application method, the wear and fracture resistant materials are applied using a thermal spray technique, such as laser cladding, plasma transferred arc, flame spray, or oxyacetylene welding deposition.

Drilling equipment having high thermal conductivity wear and fracture resistant surfaces, prepared according to an embodiment of this invention, can have a surface layer thickness in the range of from 0.1 to 10 mm, optionally from 0.5 to 8 mm, optionally from 1.0 to 5 mm. It is to be understood that the exact surface layer thickness will vary within this range depending on the choice of composite material, the drill bit substrate, and the drill bit application.

Tungsten carbide, either in the form of WC and/or W₂C, can be used to provide hardness and toughness to the wear and fracture resistant composite material. Three different tungsten carbides can be used: Spherical Cast WC/W₂C, Cast and Crushed WC/W₂C, and Macro-crystalline WC. For hardness properties the Spherical Cast WC/W₂C has greater hardness than Cast and Crushed WC/W₂C, which in turn has greater hardness than Macro-crystalline WC. For toughness properties the Spherical Cast WC/W₂C has greater toughness than Macro-crystalline WC, which in turn has greater toughness than Cast and Crushed WC/W₂C. The thermal conductivity of WC and W₂C are not substantially different. Therefore to optimize the hardness and toughness properties of the wear and fracture resistant composite material the use of Spherical Cast WC/W₂C is desired.

According to an embodiment of the present invention Spherical Cast WC/W₂C provides at least half of the total tungsten carbide by volume percent. In alternate embodiments the Spherical Cast WC/W₂C provides at least 60 percent of the total tungsten carbide, optionally at least 70 percent and optionally at least 80 percent.

Conventional hardmetal material generally consists of a binder material consisting of Co, Ni, Fe, Cr, B and alloys thereof. A low thermal conductivity has been stated as a preferred property of a hardmetal, such as in U.S. Pat. No. 6,521,353 to Majagi et al. In the present invention it is found that high thermal conductivity is a desired property of the hardmetal binder material. A hardmetal binder material having high thermal conductivity has been shown to provide reduced cracking from the application process. A hardmetal binder material having high thermal conductivity has also been shown to provide good wear resistance and provide greater resistance to thermal stress when used in drilling applications.

A comparison of thermal conductivity of various compounds of the binder are listed in Table 1, the data coming from the Handbook of Refractory Compounds by G. V. Samsonov and I. M. Vinitskii, IFI/PLENUM Data Company, 1980.

TABLE 1

| | Thermal Conductivity, | Thermal Conductivity, |
|---|---|---|
| Phase | W/(m · °K) | cal/(cm · sec · ° C.) |
| Cr₄B | 10.97 | 0.0262 |
| Cr₄B | 10.89 | 0.026 |
| CrB | 20.10 | 0.048 |
| Cr₂B₅ | 18.00 | 0.043 |
| Fe₂B | 30.14 | 0.072 |
| Co₃B | 17.00 | 0.0406 |
| Co₂B | 13.98 | 0.0334 |
| CoB | 17.00 | 0.0406 |
| Ni₃B | 41.87 | 0.1 |
| Ni₂B | 54.85 | 0.131 |

The data in Table 1 shows that a nickel based hardmetal binder provides a higher thermal conductivity binder matrix than the others that are listed. Compounds that include cobalt, iron, or chromium have significantly lower thermal conductivity than the nickel based binder. Embodiments of the present invention utilize a binder having nickel-boron compounds having a thermal conductivity greater than 0.074 cal/(cm·sec·° C.) or 31.0 W/(m·° K) and avoiding compounds with chromium, cobalt or iron which have low thermal conductivity.

Silica (Si) and Boron (B) are elements that can be used in the binder phase of a hardmetal composition. During the deposition of the hardmetal the Si in the binder can oxidize to SiO₂, which can form as a slag on the top of the surface of the hardfacing. Si in the form of slag on the surface can be removed and is herein not considered as a part of the hardfacing composition. Although NiSi₃ is possible to be formed during deposition and coexist with NiB₃, no NiSi₃ phase was observed in the hardfacing of the examples.

In an embodiment the binder contains less than 1.0 wt % of compounds other than nickel, boron and silica. In alternate embodiments the binder contains less than 0.75 wt %, optionally less than 0.5 wt %, or optionally less than 0.25 wt % materials other than nickel, boron and silica.

The deposition of the hardfacing material onto the underlying metal can be dependent on the fluidity of the hardfacing material during the application. A good fluidity will lead to better bonding and a more even distribution of the hardmetal materials and a more consistent application thickness. A number of samples of hardmetal having various binder compositions and various tungsten carbide loadings were applied to observe the fluidity characteristics. Table 2 shows the results of these tests.

TABLE 2

| | | | | Si + B in | |
|---|---|---|---|---|---|
| | WC/W₂C | Binder | WC/W₂C | Binder | |
| Sample | (wt %) | (wt %) | Shape | (wt %) | Fluidity |
| 1 | 70 | 30 (Ni—3.39Si—1.78B) | spherical | 5.17 | poor |
| 2 | 75 | 25 (Ni—4.56Si—3.27B) | spherical | 7.83 | good |
| 3 | 80 | 20 (Ni—4.56Si—3.27B) | spherical | 7.83 | good |
| 4 | 70 | 30 (Ni—3.98Si—2.53B) | spherical | 6.51 | good |
| 5 | 70 | 30 (Ni—1.0Cr—3.3Si—1.6B—0.75Fe) | spherical | 4.90 | poor |
| 6 | 70 | 30 (Ni—3.39Si—1.78B) | angular | 5.17 | poor |
| 7 | 55 | 45 (Ni—3.51Si—1.93B) | spherical | 5.44 | good |
| 8 | 58 | 42 (Ni—3.51Si—1.93B) | spherical | 5.44 | good |
| 9 | 70 | 30 (Ni—4.56Si—3.27B) | spherical | 7.83 | good |
| 10 | 65 | 35 (Ni—4.56Si—3.27B) | spherical | 7.83 | good |
| 11 | 65 | 35 (Ni—3.98Si—2.53B) | spherical | 6.51 | good |
| 12 | 60 | 40 (Ni—3.98Si—2.53B) | spherical | 6.51 | good |
| 13 | 60 | 40 (Ni—3.39Si—1.78B) | spherical | 5.17 | poor |
| 14 | 60 | 40 (Ni—3.51Si—1.93B) | spherical | 5.44 | poor |
| 15 | 68 | 32 (Ni—9.5Cr—3Fe—3Si—1.6B—0.3) | spherical | 4.8 | Prior Art |
| 16 | 60 | 40 (Ni—9.5Cr—3Fe—3Si—1.6B—0.3) | spherical | 4.8 | Prior Art |

In general the data in Table 2 indicates that the samples having greater Si+B content exhibit better fluidity than comparable compositions having a lower Si+B content.

Both Samples 4 and 5 are hardmetals having 70 wt % tungsten carbide and 30 wt % of a nickel based binder. Sample 4 has a non-Ni content of 6.51 wt % that is made up of Si and B, and exhibited good fluidity properties. Sample 5 has a non-Ni content of 6.65 wt %, of which 1.0 wt % is Cr, 0.75 wt % is Fe, and a Si+B content of 4.90 wt %. Sample 5 exhibited poor fluidity. The 1.75 wt % of Cr+Fe changed the binder characteristic from one of good fluidity to one of poor fluidity. It is desirable that the content of binder components other than Ni, Si and B be less than 1.5 wt %. In embodiments it is desirable that the content of binder components other than Ni, Si and B be less than 1.25 wt % and optionally less than 1.0 wt %.

Samples 1 and 6 are identical other than Sample 1 is composed of spherical tungsten carbide while Sample 6 is composed of angular (non-spherical) tungsten carbide. Both Samples 1 and 6 exhibited poor fluidity.

Samples 15 and 16 are commercially available hardmetal compositions and are available from Technogenia S.A. under the names Technosphere® GG and LaserCarb®.

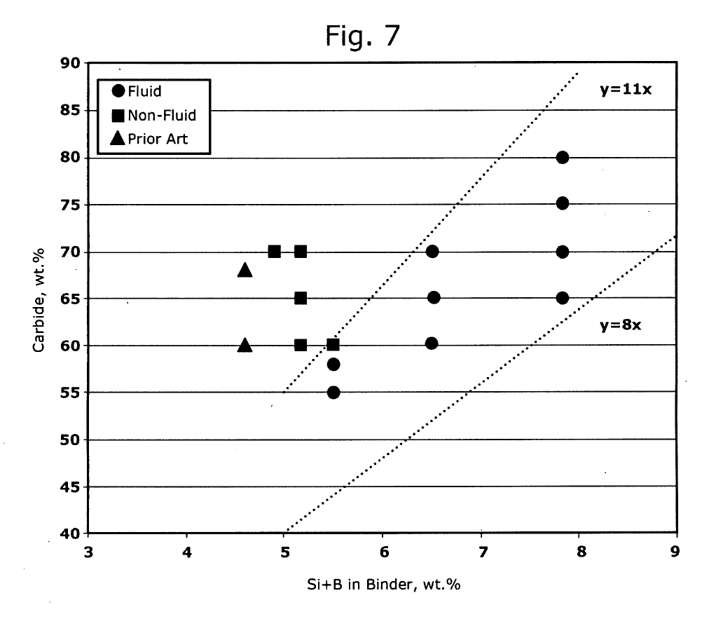

FIG. 7 is a graph of the data from Table 2 that illustrates the effect of the content of the boron and silica in the binder. The boron plus silica in the binder can be referred to herein as the binder flux. As the binder flux increases the carbide content can be increased while maintaining good fluidity. Carbide contents of 65 wt % and 70 wt % are achieved with good fluidity at a binder flux content above 6 wt %. At binder flux content above 7 wt % good fluidity is maintained with carbide contents of greater than 70 wt %.

Fluidity is observed for hardmetal compositions having carbide content (wt %) up to eleven times the binder flux content (wt %) in the binder composition. The dashed line in FIG. 6 indicates a ratio of 11:1 of the carbide content to the binder flux content. In one embodiment the carbide content (wt %) of the hardmetal compositions is between eight to eleven times the binder flux content (wt %) in the binder composition. In another embodiment the carbide content (wt %) of the hardmetal compositions is between nine to eleven times the binder flux content (wt %) in the binder composition.

Samples 15 and 16 are the commercially available hardmetal compositions and are indicated by a triangle shape in FIG. 6. Both Samples 15 and 16 are located in the non-fluid region.

A high thermal conductivity binder with a composition that provides good fluidity has been found to reduce the propensity for unwanted thermal stress cracking in the hardmetal material layer. This combination of binder components has been found to improve wear and abrasion resistance of the hardmetal and to reduce cracking due to thermal stresses both in both the application process and while in use. The improvement of fluidity can also enable a thicker layer of the hardmetal to be applied to the underlying metal, thus providing added resistance to wear and extending the life of the equipment.

Due to the improved thermal properties of the hardmetal of the present invention, tests of the hardmetal have been air cooled without cracking, without the requirement for insulation. Other hardmetal in commercial use requires insulation to be used during the cooling process to prevent cracking from occurring.

Drill bits and other drilling equipment having wear and fracture resistant surfaces formed from the composite hardmetal and/or binder materials according to the compositions and methods described herein can provide advantages when contrasted with a conventional hardfacing formed from conventional hardmetal material in that they can provide a consistent hardmetal material microstructure with a reduction of the unwanted effects of thermal applications, e.g., the introduction of unwanted thermal stress-related cracks into the material microstructure. They can provide a surface layer or a surface feature with greater resistance to wear, thermal stress and material loss. They can further provide an ability to achieve a reproducible and dimensionally consistent hardmetal layer thickness.

As a result of these advantages, surfaces having wear and fracture resistant hardmetal surfaces of this invention provide improved properties of wear and fracture resistance when compared to surfaces protected by hardfacing formed from conventional hardmetal materials, thereby increasing the resulting service life of the drill bits or other equipment comprising the same.

Two samples, Sample A of the hardmetal of the present invention having a composition of 70 wt % WC/W₂C and a binder composition of 30 wt % composed of (Ni-4.56Si-3.27B) and Sample B having 55 wt % WC/W₂C and a binder composition of 35 wt % of (Ni-3.39Si-1.78B) were tested for low stress abrasion resistance (ASTM G65) and high stress abrasion resistance (ASTM B611) and two standard commercially available hardfacings, Samples D, and E. A material used to make matrix body drill bits was also used as a comparative sample. Sample C is a tungsten carbide matrix body bit material manufactured by infiltrating tungsten carbide particles, macrocrystalline WC or chill-cast and crushed WC/W₂C, or a mixture thereof, with a Cu—Ni—Mn—Zn alloy, comprising a 66 vol % WC content in a Cu based alloy (Cu-15Ni-24Mn-8Zn). Sample C is commercially available from Kennametal, Inc. Sample D is a commercial hardfacing having 55 wt % angular WC/W₂C and a 45 wt % binder composition (Ni-7.5Cr-3Fe-3.5Si-1.5B-0.3C) available as Eutectic 8913 from Eutectic Corporation. Sample E is a commercial hardfacing having 68 wt % spherical WC/W₂C and a 32 wt % binder composition (Ni-9.5Cr-3Fe-3Si-1.6B-0.6C) available as Technosphere GG from Technogenia S.A.

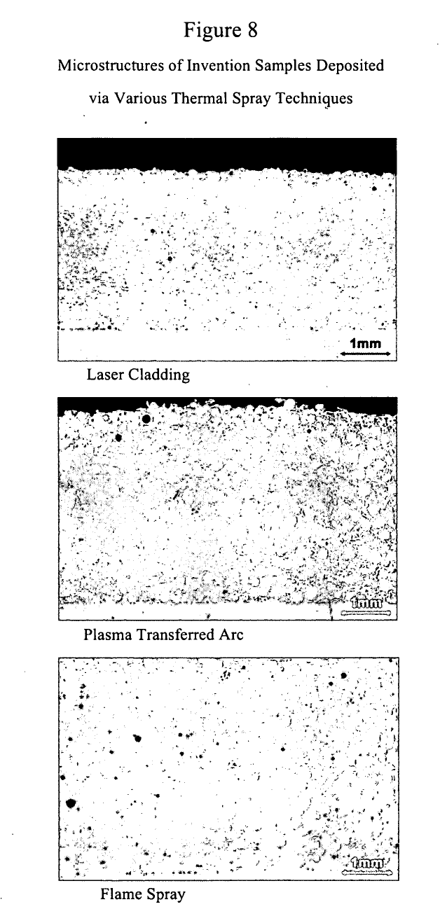

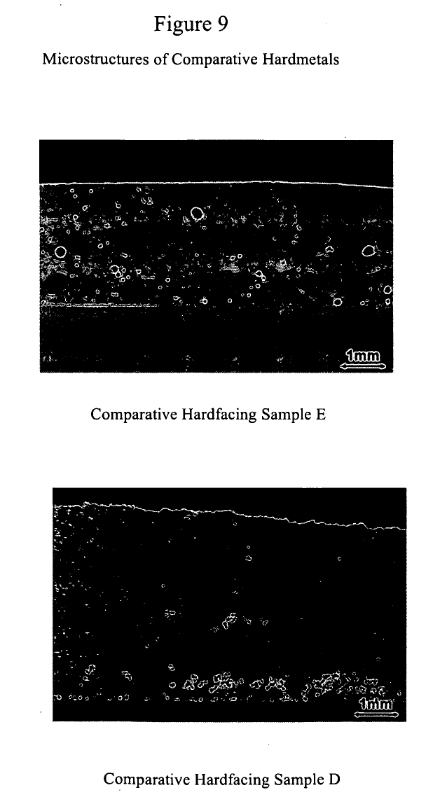

Microstructure images of embodiments of the present invention applied by various thermal spray techniques are shown in FIG. 8 indicating a crack-free and dense structure with uniform distribution of spherical WC/W₂C particles throughout the inlay thickness. Microstructure images of Comparative Samples D and E are shown in FIG. 9 exhibiting pores and micro-cracks throughout the inlay thickness.

The test results indicate that the hardmetal of the present invention utilizing a flame spray application process, Sample A, resulted in better resistance as compared to the commercially available hardfacings while the hardmetal of the present invention utilizing a laser cladding application process, Sample B, containing relatively low content of WC/W₂C, has comparable resistance to the commercially available hardfacings. The abrasion resistance test data are shown in Table 3 below.

TABLE 3

| | | High Stress |
|---|---|---|
| | Low Stress Abrasion | Abrasion ASTM |
| | ASTM G65 | B611 (cm³/1000 |
| Sample | (cm³/1000 revolution) | revolution) |
| A (flame spray) | 0.78 | 0.36 |
| B (laser clad) | 1.50 | 0.52 |
| C (comparative | 1.67 | 1.23 |
| matrix bit | | |
| material) | | |
| D (comparative | 3.38 | 0.75 |
| hardmetal) | | |
| E (comparative | 1.33 | 0.42 |
| hardmetal) | | |

Embodiments of the present invention include a hardmetal composition having a low stress abrasion of 2.0 cm³/1000 revolution or less, optionally 1.7 cm³/1000 revolution or less, optionally 1.5 cm³/1000 revolution or less, optionally 1.3 cm³/1000 revolution or less, optionally 1.0 cm³/1000 revolution or less. Embodiments of the present invention include a hardmetal composition having a high stress abrasion of 1.0 cm³/1000 revolution or less, optionally 0.75 cm³/1000 revolution, optionally 0.6 cm³/1000 revolution or less, optionally 0.5 cm³/1000 revolution or less.

The terms “hardmetal,” “hardfacing,” “hardfaced layer,” and the like as used herein refers to a layer of carbide containing material that is placed onto an underlying substrate, such as onto an underlying drill bit body.

Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

1. A high thermal conductivity hardmetal composition comprising:
tungsten carbide in an amount greater than 50 weight percent of the hardmetal composition, the tungsten carbide having at least 50 volume percent of spherical tungsten carbide particles; and
a binder material consisting of at least 90 weight percent nickel, a binder flux of between 3.5 to 10.0 weight percent chosen from the group consisting of boron and silica, and less than 1.0 weight percent other components.

2. The hardmetal of claim 1, wherein the tungsten carbide is present in an amount between 50 to 90 weight percent.

3. The hardmetal of claim 1, wherein the tungsten carbide is present in an amount between 55 to 80 weight percent.

4. The hardmetal of claim 1, having good deposition fluidity and having a tungsten carbide content (wt %) in the hardmetal from eight to eleven times the binder flux content (wt %) of the binder.

5. The hardmetal of claim 1, wherein the hardmetal has a low stress abrasion of less than 2.0 cm³/1000 revolution.

6. The hardmetal of claim 1, wherein the hardmetal has a high stress abrasion of less than 1.0 cm³/1000 revolution.

7. The hardmetal of claim 1 applied to an underlying metal via a thermal spray technique.

8. The hardmetal of claim 7, wherein the thermal spray technique is chosen from the group of laser cladding, plasma transferred arc, and flame spray.

9. The hardmetal of claim 1, wherein the binder material has a thermal conductivity of greater than 31.0 Watt/m·° K.

10. The hardmetal of claim 1, wherein the hardmetal has a low stress abrasion of less than 1.3 cm³/1000 revolution and a high stress abrasion of less than 0.50 cm³/1000 revolution.

11. The hardmetal of claim 1, applied by a thermal spray technique to a tool chosen from the group consisting of drill bit, rotary cone bit, drag bit, mill tooth bit, reamer, under-reamer, stabilizer and centralizer.

12. A drill bit comprising:
a bit body;
at least one high thermal conductivity hardmetal surface affixed to the bit body;
the hardmetal comprising tungsten carbide in an amount greater than 50 weight percent of the hardmetal composition, the tungsten carbide having at least 50 volume percent of spherical tungsten carbide particles;
the hardmetal further comprising a binder material consisting of at least 90 weight percent nickel, a binder flux of between 3.5 to 10.0 weight percent chosen from the group consisting of boron and silica, and less than 1.0 weight percent other components.

13. The bit of claim 12, wherein the drill bit is a rotary cone bit.

14. The bit of claim 12, wherein the drill bit is a drag bit.

15. The bit of claim 12, wherein the hardmetal has a low stress abrasion of less than 1.3 cm³/1000 revolution and a high stress abrasion of less than 1.0 cm³/1000 revolution.

16. The bit of claim 12, wherein the hardmetal is applied to the bit body via a thermal spray technique.

17. The bit of claim 12, wherein the thermal spray technique is chosen from the group of laser cladding, plasma transferred arc, and flame spray.

18. The bit of claim 12, wherein the hardmetal binder material has a thermal conductivity of greater than 31.0 Watt/m·° K.

19. A method for providing a wear resistant material onto a tool comprising:
providing a hardmetal composition consisting of tungsten carbide in an amount greater than 50 weight percent of the hardmetal composition, the tungsten carbide having at least 50 volume percent of spherical tungsten carbide particles and a binder material consisting of at least 90 weight percent nickel, a binder flux of between 3.5 to 10.0 weight percent chosen from the group consisting of boron and silica, and less than 1.0 weight percent other components;
affixing the hardmetal composition to portions of the tool.

20. The method of claim 19, wherein the tungsten carbide is present in an amount between 55 to 80 weight percent.

21. The method of claim 19, wherein the hardmetal composition has good deposition fluidity and the tungsten carbide content (wt %) in the hardmetal is from eight to eleven times the binder flux content (wt %) of the binder.

22. The method of claim 19, wherein the hardmetal is applied to the tool via a thermal spray technique.

23. The method of claim 22, wherein the thermal spray technique is chosen from the group of laser cladding, plasma transferred arc, and flame spray.

24. The method of claim 19, wherein the tool is chosen from the group consisting of drill bit, rotary cone bit, drag bit, mill tooth bit, reamer, under-reamer, stabilizer and centralizer.

25. A high thermal conductivity hardmetal composition comprising:
tungsten carbide in an amount greater than 60 wt % of the hardmetal composition, the tungsten carbide having at least 50 vol % of spherical tungsten carbide particles;
a binder material consisting of a ductile Ni—B—Si matrix composed of at least 98.5 wt % of components selected from the group consisting of: nickel, boron, and silica, the binder material having a binder flux content of boron plus silica ranging from 5.0 to 9.0 wt % of the binder material;
wherein the binder material has a thermal conductivity of greater than 31.0 Watt/m·° K;
wherein the hardmetal composition has good deposition fluidity and the tungsten carbide content wt % in the hardmetal composition ranges from eight to eleven times the binder flux content wt % of the binder;
wherein the hardmetal composition has a low stress abrasion of less than 2.0 cm³/1000 revolution; and
wherein the hardmetal composition has a high stress abrasion of less than 0.75 cm³/1000 revolution.
